(19) United States
(12) Patent Application Publication
(10) Pub. No.: US 2014/0015816 A1
(43) Pub. Date: Jan. 16, 2014

(54) DRIVING MULTIPLE DISPLAYS USING A SINGLE DISPLAY ENGINE

(71) Applicants: Scott Janus, Rocklin, CA (US); George Hayek, El Dorado Hills, CA (US)

(72) Inventors: Scott Janus, Rocklin, CA (US); George Hayek, El Dorado Hills, CA (US)

(21) Appl. No.: 13/977,419

(22) PCT Filed: Dec. 16, 2011
(86) PCT No.: PCT/US11/65491

§ 371 Date: Sep. 30, 2013

(51) Int. Cl. G09G 3/00

(52) U.S. Cl. CPC G09G 3/00
USPC 345/204

(57) ABSTRACT

Systems, devices and methods are described including using a display engine to render first image content at a first rate, where the first image content is to be displayed by a first display at a second rate, where the first rate is larger than the second rate. The display engine may also be used to render second image content at the first rate, where the second image content is to be displayed by the second display at the second rate.

### BACKGROUND

An important component of any media device (including PCs, phones, set-top boxes, game consoles, etc.) is a display engine. This display engine converts a frame buffer in memory into electrical signals that are sent over a bus to an actually display device, such as a TV or computer monitor. These display engines may include processing operations such as color space conversion, gamut correction, as well as sprite/overlay composition. Typically, display engines run in real-time so that they transmit exactly one pixel per clock to the display device.

To provide a unique image on two or more associated displays, conventional products employ one dedicated display engine for each associated display device. Thus, existing systems use a one-to-one-to-one pairing between frame buffer, display engine, and display device. For example, a typical computing system driving three monitors in extended desktop mode requires three display engines. However, employing multiple display engines consumes significant hardware resources.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system;

FIG. 2 is an illustrative diagram of another example system

FIG. 3 is a flow diagram illustrating an example process;

FIG. 4 is an illustrative diagram of an example timing scheme;

FIG. 5 is an illustrative diagram of another example timing scheme;

FIG. 6 is an illustrative diagram of an example system; and

FIG. 7 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

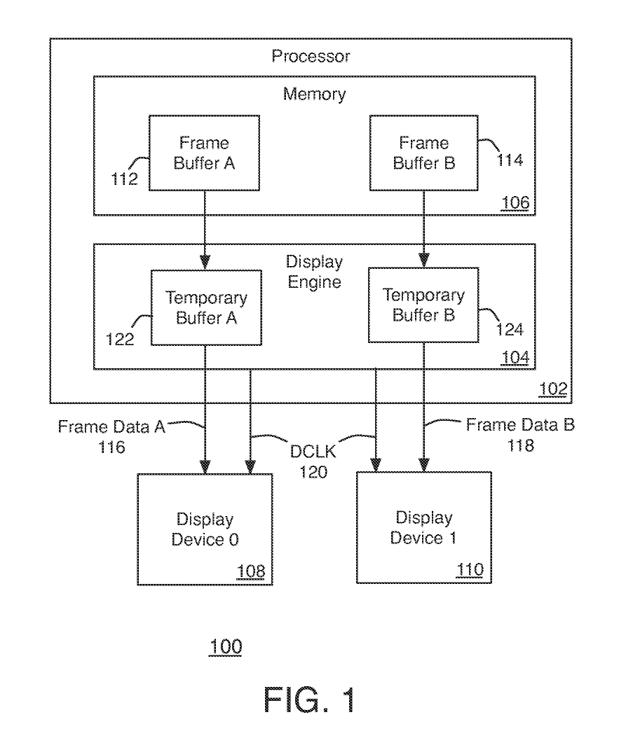

FIG. 1 illustrates an example system 100 in accordance with the present disclosure. In various implementations, system 100 includes a processor 102 including a display engine 104, and memory 106. Processor 102 is operatively and communicatively coupled to a pair of displays 108 and 110. In various implementations, memory 106 may contain two frame buffers 112 (frame buffer A) and 114 (frame buffer B) that store image data corresponding to frame data 116 (frame data A) and 118 (frame data B), respectively. In various implementations, frame data 116 may correspond to image content to be displayed on display 108, while frame data 118 may correspond to different image content to be displayed on display 110.

Displays 108 and 110 may display frame data 116 and 118 at a display refresh rate of, for example, 60 hertz. Displays 108 and 110 may do so in response to a display clock signal 120 (DCLK) provided by display engine 104. For example, in response to DCLK signal 120, displays 108 and 110 may display frame data 116 and 118, respectively, at a rate of sixty (60) hertz. For example, display 108 may display all pixels of frame data 116 sixty times a second or once every one sixtieth ( 1/60) of a second by displaying one pixel of frame data 116 at a real time rate of one pixel per pulse of DCLK signal 120.

In various implementations, display engine 104 may access frame buffer 112 to obtain image data for display 108 and render it as frame data 116 before storing it in a temporary buffer 122 (temporary buffer A) internal to engine 104. Similarly, display engine 104 may access frame buffer 114 to obtain different image data for display 110 and render it as frame data 118 before storing it in another temporary buffer 124 (temporary buffer B) also internal to engine 104. In various implementations, as will be explained in greater detail below, display engine 104 may render image data into a temporary buffers 122 and 124 at a rate that is at least twice as fast as the display refresh rate of displays 108 and 110. For example, display engine 104 may render image data into temporary buffers 122 and 124 at a rate of at least one-hundred twenty (120) hertz. By rendering image data to temporary buffers 122 and 124 at twice the rate or more at which displays 108 and 110 display their respective images, display engine 104 may simultaneously provide separate and distinct images at the same time to display 108 and display 110.

In various implementations, display engine 104 may render image data into a temporary buffers 122 and 124 at a rate of N times the rate at which displays 108 and 110 display images, where N may be a positive integer number greater than one (e.g., 2, 3, 4 . . . ). However, the present disclosure is not limited to integer differences between the rate at which image data is rendered into temporary buffers 122 and 124 and the rate at which displays 108 and 110 display their respective images. Thus, in various implementations, N may be a positive non-integer number greater than one.

Further, while system 100 depicts two displays 108 and 110, the present disclosure is not limited in this regard, and, in various implementations, display engine 104 may render image data into a temporary buffers 122 and 124 at a rate sufficient to support simultaneous display of independent images by two or more displays. For example, to support simultaneous display of independent images by four displays, each operating at 60 hertz, a display engine in accordance with the present disclosure may render image data into four separate temporary buffers at a rate of 240 hertz.

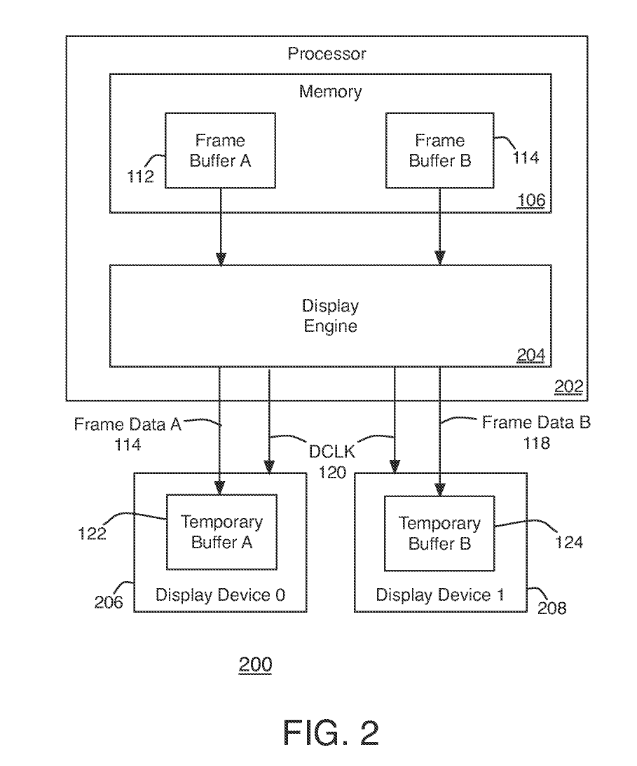

FIG. 2 illustrates another example system 200 in accordance with the present disclosure. In various implementations, system 200 includes some elements such as memory 106, frame buffers 112 and 114, temporary buffers 112 and 124, frame data 116 and frame data 118 that are similar to and function in the same manner as described above with respect to system 100. However, in contrast to system 100, a processor 202 of system 200 includes a display engine 204 that does not include temporary buffers 122 and 124, rather, in system 200, temporary buffers 122 and 124 are located internal to respective displays 206 and 208. In a manner similar to that described above with respect to system 100, display engine 204 of system 200 may render image data to temporary buffers 122 and 124 at twice the rate at which displays 206 and 208 display their respective images, so that display engine 204 may simultaneously provide separate and distinct images at the same time to display 206 and display 208.

In various implementations, referring to both FIGS. 1 and 2, memory 106 may be either internal or external to processor 102 or 202 and may be provided by any type of memory system, device or technology. For example, memory 106 may be any type of volatile memory such as any type of Static Random Access Memory (SRAM), any type of Dynamic Random Access Memory (DRAM), and so forth. Further, in various implementations, memory 106 may correspond to system memory of a computing system that includes processor 102 or processor 202. Further, in various implementations, temporary buffers 112 and 124 may also be any type of memory system, device or technology. For example, temporary buffers 112 and 124 may be SRAM memory.

In various implementations, various forms of hardware logic and/or circuitry may provide display engine 204. For example, in various embodiments, an application specific integrated circuit (ASIC) may implement display engine 204. However, the present disclosure is not limited in this regard and display engine 204 may be provided by software and/or firmware instructions executed by processing logic such as one or more central processing unit (CPU) processor cores, a digital signal processor (DSP), a Fully Programmable Gate Array (FPGA), and so forth.

The systems depicted in FIGS. 1 and 2 are provided herein as example systems and the present disclosure is not limited to the examples of systems 100 and 200. Thus, for example, while systems 100 and 200 depict display engines 104 and 204 as internal to processors 102 and 202, respectively, in various implementations, display engine 104 and/or 204 may be external to their respective processors. Further, display 108 and/or display 110 in system 100, and/or display 206 and/or display 208 in system 200, may be coupled to respective display engines 104 and 204 using any wired or wireless techniques and/or technologies. For example, in some implementations, display 108 and/or display 110 may be wirelessly coupled to engine 104 using any known wireless display techniques such as WiDi or the like. In other implementations, display 108 and/or display 110 may be coupled to engine 104 using any combination of signal traces, buses, cables or the like.

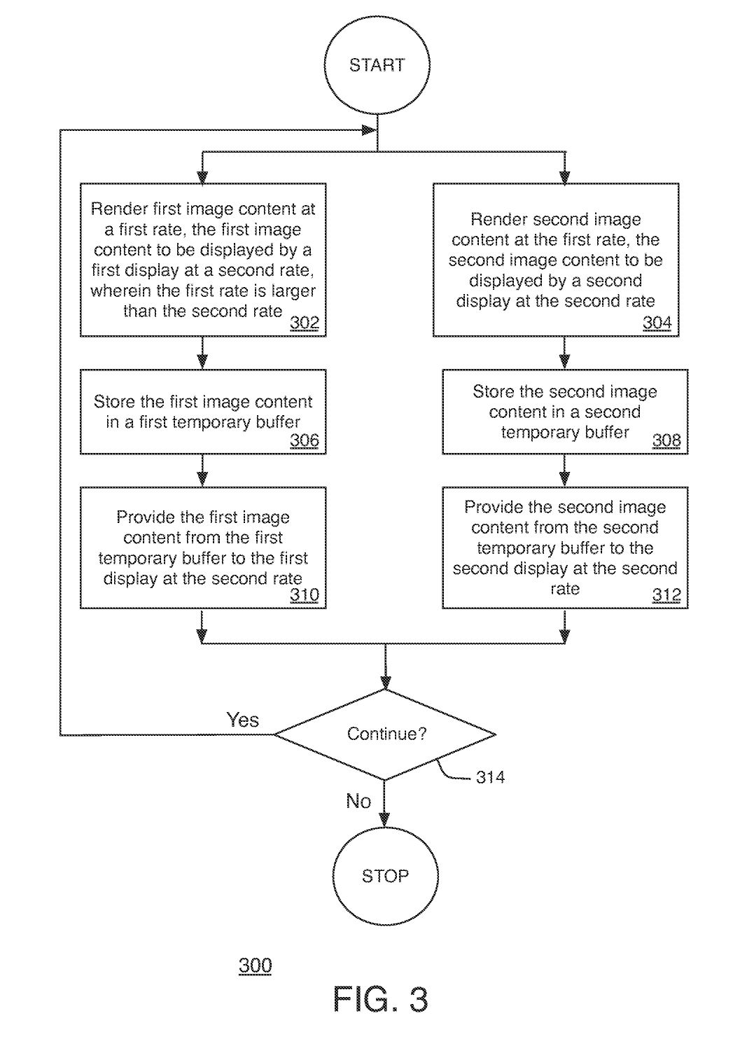

FIG. 3 illustrates a flow diagram of an example process 300 according to various implementations of the present disclosure. Process 300 may include one or more operations, functions or actions as illustrated by one or more of blocks 302, 304, 306, 310, 312 and 314 of FIG. 3. By way of non-limiting example, process 300 will be described herein with reference to example system 100 of FIG. 1.

Process 300 may begin at block 302 where first image content may be rendered at a first rate, where the first image content is to be displayed by a first display at a second rate, wherein the first rate is larger than the second rate. In various implementations, block 302 may involve display engine 104 accessing frame buffer 112 to obtain image data and to render that data into image content to be provided to display 108 as frame data 116. When doing so, display engine 104 may render the image data into frame data 116 at a first rate that is faster than a second rate that display 108 will display frame data 116. As discussed previously, the rate at which display engine 104 renders frame data 116 may be N times the real time rate at which frame data 116 is displayed. In various implementations, N may be a positive integer greater than one. For example, display 108 displays frame data 116 at 60 hertz, display engine 104 may render frame data 116 at a rate of 120 hertz, 180 hertz, 240 hertz or higher.

At block 304 the second image content may be rendered at the first rate, where the second image content is to be displayed by a second display at the second rate. In various implementations, block 304 may involve display engine 104 accessing frame buffer 114 to obtain image data and to render that data into image content to be provided to display 110 as frame data 118. When doing so, display engine 104 may render the image data into flame data 118 at the same rate employed at block 302 for frame data 116.

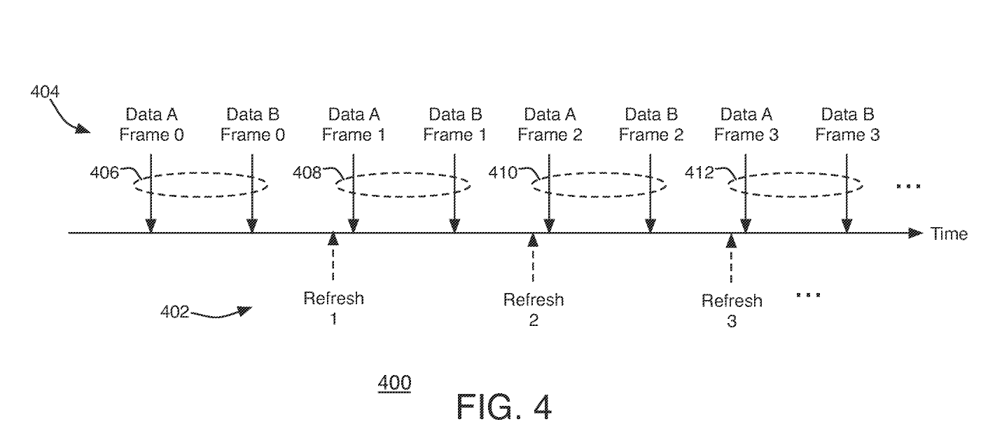

For instance, FIG. 4 illustrates an example timing scheme 400 where a sequence of display refresh events 402 (e.g., refresh 0, refresh 1, refresh 2, etc) are represented at a first rate (e.g., 60 hertz) and correspond to the rate at which displays 108 and 110 will display all pixels of frame data 114 and 116, respectively. Scheme 400 also depicts a sequence of rendering events 404 (e.g., data A frame 0, data B frame 0, etc) where a first two rendering events 406 correspond to a first iteration of blocks 302 and 304 (e.g., data A frame 0 corresponds to frame data 116, and data B frame 0 corresponds to frame data 118). As depicted in scheme 400, the rate of rendering events 404 is twice the rate of refresh events 402. However, scheme 400 is presented herein for illustrative purposes and the present disclosure is not limited to any particular rate difference and/or timing offset between rendering events and display or refresh events.

Process 300 may continue at blocks 306 and 308 where, respectively, the first image content may be stored in a first temporary buffer and the second image content may be stored in a second temporary buffer. In various implementations, block 306 may involve display engine 104 storing frame data 116 in temporary buffer 122 at the same rate employed at block 302, while block 308 may involve display engine 104 storing frame data 118 in temporary buffer 124 at the same rate. While blocks 306 and 308 have been described above in the context of system 100 where the temporary buffers are integrated into the display engine, in various implementations, such as system 200 of FIG. 2, where the temporary buffers are integrated into the corresponding displays (e.g., displays 206 and 208) rather than the display engine, blocks 306 and 308 may involve the display engine providing the frame data to the temporary buffers of the respective displays at the same rate at which the display engine rendered the frame data.

Process 300 may continue at blocks 310 and 312 where, respectively, the first image content may be provided from the first temporary buffer to the first display at the second rate, and the second image content may be provided from the second temporary buffer to the second display at the second rate. In various implementations, block 310 may involve display engine 104 providing frame data 116 from temporary buffer 122 to display 108 at the display refresh rate, while block 312 may involve display engine 104 providing frame data 118 from temporary buffer 124 to display 110 at the same display rate. Again, while blocks 310 and 312 have been described above in the context of system 100 where the temporary buffers are integrated into the display engine, in various implementations, such as system 200 of FIG. 2, where the temporary buffers are integrated into the corresponding displays (e.g., displays 206 and 208) rather than the display engine, blocks 310 and 312 may not be undertaken as the temporary buffers are integrated into the displays.

Process 300 may continue at block 314 where a determination may be made as to whether to continue process 300. If the result of block 314 is positive, then process 300 may loop back to blocks 302 and 304 where process 300 may be repeated. For example, referring to scheme 400, process 300 may continue with a subsequent rendering event 408 (e.g., data A frame 1, data B frame 1, etc) corresponding to a second iteration of blocks 302 and 304, and so forth where repeated iterations of blocks 302 and 304 correspond to further rendering events 410, 412 and so forth.

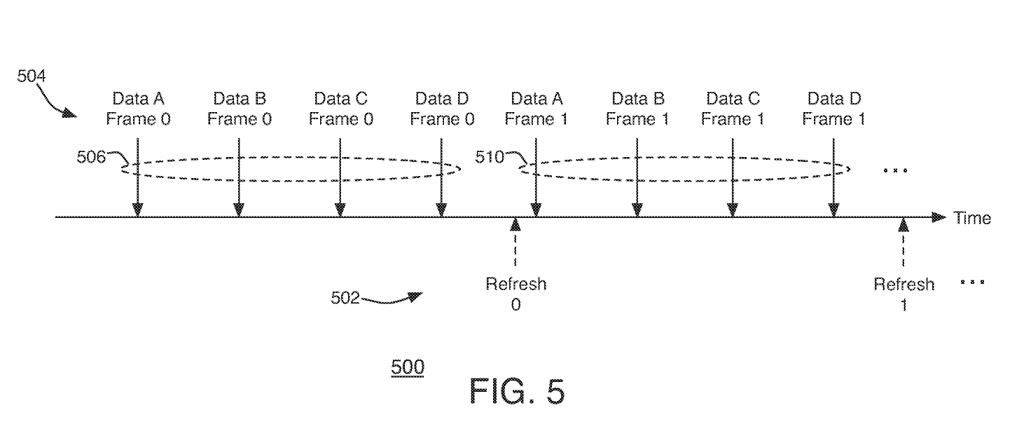

While process 300 has been described above with reference to scheme 400, the present disclosure, as noted above, is not limited to any particular timing scheme having any particular rate difference and/or timing offset between rendering events and display events. Thus, for example, FIG. 5 illustrates another example timing scheme 500 where a sequence of display events 502 are represented at a first rate corresponding to the display rate while a sequence of rendering events 404 are occurring at a rendering rate that if four times the display rate. For example, as depicted in FIG. 5, scheme 500 includes rendering events for four different frames (e.g., A, B, C and D corresponding to frame data for four distinct displays) that may correspond to two example iterations 506 and 510 of process 300 as may be undertaken for systems having four rather than two displays.

While implementation of example process 300, as illustrated in FIG. 3, may include the undertaking of all blocks shown in the order illustrated, the present disclosure is not limited in this regard and, in various examples, implementation of process 300 may include the undertaking only a subset of the blocks shown and/or in a different order than illustrated.

In addition, any one or more of the blocks of FIG. 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIG. 3 in response to instructions conveyed to the processor by a computer readable medium.

As used in any implementation described herein, the term “module” refers to any combination of software, firmware and/or hardware logic configured to provide the functionality described herein. The software logic may be embodied as a software package, code and/or instruction set or instructions, and “hardware”, as used in any implementation described herein, may include, for example, singly or in any combination, hardware logic such as hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

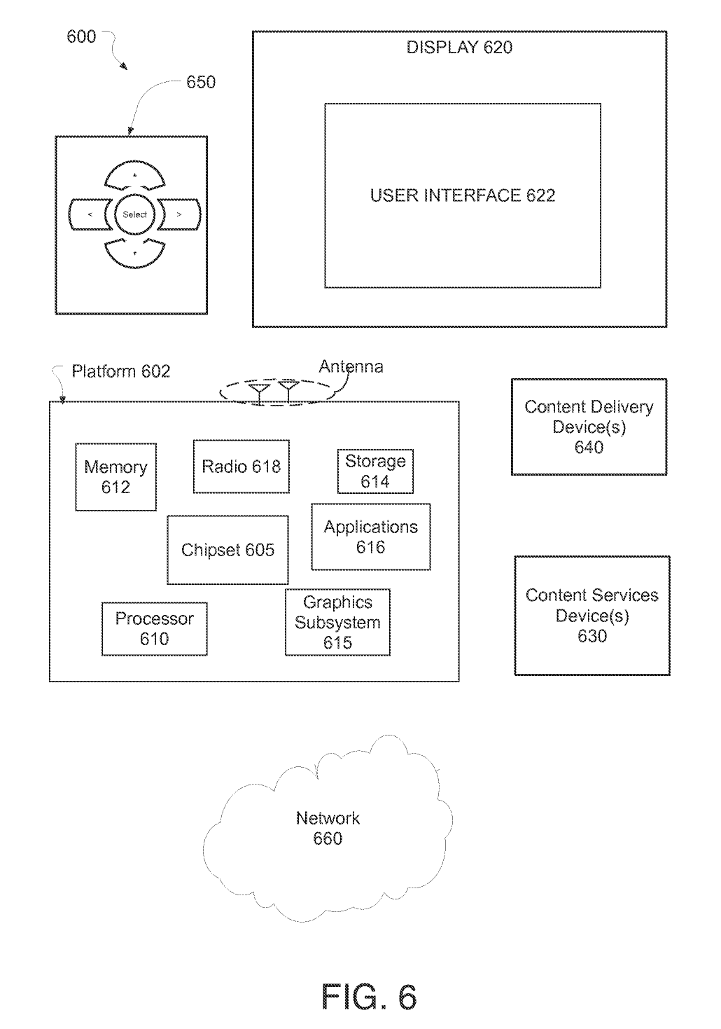

FIG. 6 illustrates an example system 600 in accordance with the present disclosure. In various implementations, system 600 may be a media system although system 600 is not limited to this context. For example, system 600 may be incorporated into a personal computer (PC), laptop computer, ultra-laptop computer, tablet, touch pad, portable computer, handheld computer, palmntop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 600 includes a platform 602 coupled to a display 620. Platform 602 may receive content from a content device such as content services device(s) 630 or content delivery device(s) 640 or other similar content sources. A navigation controller 650 including one or more navigation features may be used to interact with, for example, platform 602 and/or display 620. Each of these components is described in greater detail below.

In various implementations, platform 602 may include any combination of a chipset 605, processor 610, memory 612, storage 614, graphics subsystem 615, applications 616 and/or radio 618. Chipset 605 may provide intercommunication among processor 610, memory 612, storage 614, graphics subsystem 615, applications 616 and/or radio 618. For example, chipset 605 may include a storage adapter (not depicted) capable of providing intercommunication with storage 614.

Processor 610 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 610 may be dual-core processor(s), dual-core mobile processor(s), and so forth.

Memory 612 may be implemented as a volatile memory device such as, but not limited to, a Random Access Memory (RAM), Dynamic Random Access Memory (DRAM), or Static RAM (SRAM).

Storage 614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 614 may include technology to increase the storage performance enhanced protection for valuable digital media when multiple hard drives are included, for example.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 620. For example, the interface may be any of a High-Definition Multimedia Interface, DisplayPort, wireless HDMI, and/or wireless HD compliant techniques. Graphics subsystem 615 may be integrated into processor 610 or chipset 605. In some implementations, graphics subsystem 615 may be a stand-alone card communicatively coupled to chipset 605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In a further embodiments, the functions may be implemented in a consumer electronics device.

Radio 618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 618 may operate in accordance with one or more applicable standards in any version.

In various implementations, display 620 may include any television type monitor or display. Display 620 may include, for example, a computer display screen, touch screen display, video monitor, television-like device, and/or a television. Display 620 may be digital and/or analog. In various implementations, display 620 may be a holographic display. Also, display 620 may be a transparent surface that may receive a visual projection. Such projections may convey various forms of information, images, and/or objects. For example, such projections may be a visual overlay for a mobile augmented reality (MAR) application. Under the control of one or more software applications 616, platform 602 may display user interface 622 on display 620.

In various implementations, content services device(s) 630 may be hosted by any national, international and/or independent service and thus accessible to platform 602 via the Internet, for example. Content services device(s) 630 may be coupled to platform 602 and/or to display 620. Platform 602 and/or content services device(s) 630 may be coupled to a network 660 to communicate (e.g., send and/or receive) media information to and from network 660. Content delivery device(s) 640 also may be coupled to platform 602 and/or to display 620.

In various implementations, content services device(s) 630 may include a cable television box, personal computer, network, telephone, Internet enabled devices or appliance capable of delivering digital information and/or content, and any other similar device capable of unidirectionally or bidirectionally communicating content between content providers and platform 602 and/display 620, via network 660 or directly. It will be appreciated that the content may be communicated unidirectionally and/or bidirectionally to and from any one of the components in system 600 and a content provider via network 660. Examples of content may include any media information including, for example, video, music, medical and gaming information, and so forth.

Content services device(s) 630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 602 may receive control signals from navigation controller 650 having one or more navigation features. The navigation features of controller 650 may be used to interact with user interface 622, for example. In embodiments, navigation controller 650 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 650 may be replicated on a display (e.g., display 620) by movements of a pointer, cursor, focus ring, or other visual indicators displayed on the display. For example, under the control of software applications 616, the navigation features located on navigation controller 650 may be mapped to virtual navigation features displayed on user interface 622, for example. In embodiments, controller 650 may not be a separate component but may be integrated into platform 602 and/or display 620. The present disclosure, however, is not limited to the elements or in the context shown or described herein.

In various implementations, drivers (not shown) may include technology to enable users to instantly turn on and off platform 602 like a television with the touch of a button after initial boot-up, when enabled, for example. Program logic may allow platform 602 to stream content to media adaptors or other content services device(s) 630 or content delivery device(s) 640 even when the platform is turned “off.” In addition, chipset 605 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various embodiments, platform 602 and display 620 may be an integrated unit. Display 620 and content service device(s) 630 may be integrated, or display 620 and content delivery device(s) 640 may be integrated, for example. These examples are not meant to limit the present disclosure.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

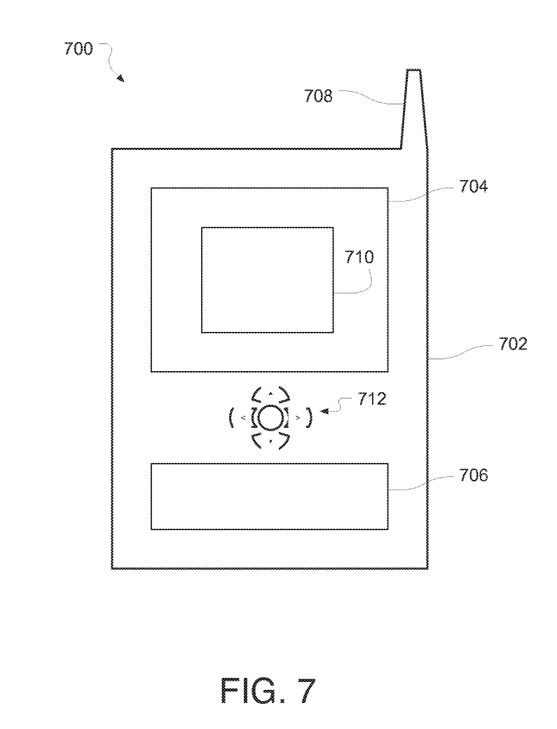

As described above, system 600 may be embodied in varying physical styles or form factors. FIG. 7 illustrates implementations of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may include a housing 702, a display 704, an input/output (I/O) device 706, and an antenna 708. Device 700 also may include navigation features 712. Display 704 may include any suitable display unit for displaying information appropriate for a mobile computing device. In various implementations, display 704 may be a passive polarization based or active barrier based auto stereoscopic display. I/O device 706 may include any suitable I/O device for entering information into a mobile computing device. Examples for I/O device 706 may include an alphanumeric keyboard, a numeric keypad, a touch pad, input keys, buttons, switches, rocker switches, microphones, speakers, voice recognition device and software, and so forth. Information also may be entered into device 700 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-30. (canceled)

31. A computer-implemented method, comprising:
at a display engine:
rendering first image content at a first rate, the first image content to be displayed by a first display at a second rate, wherein the first rate is larger than the second rate; and
rendering second image content at the first rate, the second image content to be displayed by a second display at the second rate.

32. The method of claim 31, further comprising
storing the first image content in a first temporary buffer; and
storing the second image content in a second temporary buffer.

33. The method of claim 32, wherein the display engine includes the first and second temporary buffers.

34. The method of claim 33, further comprising:
providing the first image content from the first temporary buffer to the first display at the second rate; and
providing the second image content from the second temporary buffer to the second display at the second rate.

35. The method of claim 32, wherein the first display includes the first temporary buffer, and wherein the second display includes the second temporary buffer.

36. The method of claim 35, wherein storing the first image content comprises writing the first image content to the first temporary buffer at the first rate, and wherein storing the second image content comprises writing the second image content to the second temporary buffer at the first rate.

37. The method of claim 31, wherein the first rate comprises N times the second rate, wherein N comprises a positive integer number greater than one.

38. The method of claim 31, wherein the first rate comprises N times the second rate, wherein N comprises a positive non-integer number greater than one.

39. An article comprising a computer program product having stored therein instructions that, if executed, result in:
at a display engine:
rendering first image content at a first rate, the first image content to be displayed by a first display at a second rate, wherein the first rate is larger than the second rate; and
rendering second image content at the first rate, the second image content to be displayed by a second display at the second rate.

40. The article of claim 39, further comprising
storing the first image content in a first temporary buffer; and
storing the second image content in a second temporary buffer.

41. The article of claim 40, wherein the display engine includes the first and second temporary buffers.

42. The article of claim 41, further comprising:
providing the first image content from the first temporary buffer to the first display at the second rate; and
providing the second image content from the second temporary buffer to the second display at the second rate.

43. The article of claim 40, wherein the first display includes the first temporary buffer, and wherein the second display includes the second temporary buffer.

44. The article of claim 43, wherein storing the first image content comprises writing the first image content to the first temporary buffer at the first rate, and wherein storing the second image content comprises writing the second image content to the second temporary buffer at the first rate.

45. A device, comprising:
a processor configured to use a display engine to:
render first image content at a first rate, the first image content to be displayed by a first display at a second rate, wherein the first rate is larger than the second rate; and
render second image content at the first rate, the second image content to be displayed by a second display at the second rate.

46. The device of claim 45, further comprising
storing the first image content in a first temporary buffer; and
storing the second image content in a second temporary buffer.

47. The device of claim 46, wherein the display engine includes the first and second temporary buffers.

48. The device of claim 47, further comprising:
providing the first image content from the first temporary buffer to the first display at the second rate; and
providing the second image content from the second temporary buffer to the second display at the second rate.

49. The device of claim 46, wherein the first display includes the first temporary buffer, and wherein the second display includes the second temporary buffer.

50. A system comprising:
a first display;
a second display; and
a display engine communicatively and operably coupled to the first and second displays, the display engine to render first image content at a first rate, the first image content to be displayed by the first display at a second rate, wherein the first rate is larger than the second rate; and render second image content at the first rate, the second image content to be displayed by the second display at the second rate.

51. The system of claim 50, the display engine to store the first image content in a first temporary buffer, and to store the second image content in a second temporary buffer.

52. The system of claim 51, wherein the display engine includes the first and second temporary buffers.

53. The system of claim 51, wherein the first display includes the first temporary buffer, and wherein the second display includes the second temporary buffer.

54. The system of claim 53, wherein storing the first image content comprises writing the first image content to the first temporary buffer at the first rate, and wherein storing the second image content comprises writing the second image content to the second temporary buffer at the first rate.
